(19) United States
(12) Patent Application Publication
(10) Pub. No.: US 2003/0005092 A1
(43) Pub. Date: Jan. 2, 2003

(54) Method for locating and recovering devices which are connected to the internet or to an internet-connected network

(76) Inventors: Dean S. Nelson, Meridian, ID (US); James Clough, Meridian, ID (US); Douglas J. Wiegley, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 09/896,711

(22) Filed: Jun. 28, 2001

(51) Int. Cl. G06F 15/16; G06F 15/177

(52) U.S. Cl. 709/220; 709/203

(57) ABSTRACT

A method for locating and recovering network-connected devices includes the steps of: employing one or more discovery techniques to discover devices on the Internet or on an Internet-connected computer network; acquiring identifiers of discovered devices; storing information pertaining to the discovered devices in a discovery database; accessing a database of information pertaining to devices of interest; comparing the identifiers to the database of information to identify devices of interest among the discovered devices; tracing network addresses of the identified devices of interest; and providing information pertaining to the identified devices of interest and/or the discovered devices to a party of interest. In a preferred embodiment, the network addresses of the identified devices of interest are traced through an Internet Service Provider (ISP). The party of interest is, for example, a law enforcement agency or a purchaser of market research data.

### BACKGROUND OF THE INVENTION

1. Field of Invention

The present invention relates generally to network discovery and asset management and, more specifically, to a method for locating and recovering devices such as missing or stolen hardware which are connected to the Internet or to an Internet-connected network.

2. Description of the Related Art

Devices capable of being connected to the Internet or to an Internet-connected network (hereinafter “devices”) such as computers and laser printers are frequently stolen from businesses, institutions and residences alike. Moreover, small portable devices such as notebook computers and Personal Digital Assistants (PDAs) often become “lost” within the facilities of a large business entity when they are moved to another work area, borrowed by a co-worker, etc.

It is known to configure electronic devices with transponders and various agents and programs for indicating a location of such a device after it has been stolen. It is also known to employ a database of reported stolen computers in conjunction with a computer which has been configured with a security system embedded in its software, firmware or hardware. See, U.S. Pat. No. 5,764,892 to Cain et al. These prior approaches rely upon adding some form of security system to devices which undesirably increases the cost and complexity of such devices. Accordingly, it would be useful to be able to locate and recover stolen or lost devices without having to modify them to include security paraphernalia such as described above.

It would also be useful to be able to automatically locate and identify devices which have been moved and then reconnected to the Internet or to an Internet-connected network. It would also be useful to have a method for locating and identifying devices connected throughout the Internet or other networks of interest. It would also be useful to have a “low bandwidth” method for locating and identifying devices whereby network queries are made in a manner designed to avoid overloading any individual remote network.

### SUMMARY OF THE INVENTION

The method for locating and recovering devices according to the present invention exploits the significant likelihood that stolen or lost devices will eventually be reconnected to the Internet—as much of the value of these devices often stems from their network connectivity. The method generally involves: employing one or more discovery techniques to discover network-connected devices; and acquiring identifiers of the discovered devices to create a “discovery database” of information. According to a preferred method, this discovery database is compared to a database of information pertaining to devices of interest, such as stolen or lost devices, to facilitate locating and recovering the devices of interest. According to another preferred method, information in the discovery database is provided to a party of interest, such as a law enforcement agency or a purchaser of market research data.

In accordance with one embodiment of the present invention, a “discovery server” is employed to walk the Internet to search for connected devices. When a device is found, the network address of the device and any unique identifier information, such as serial numbers and hardware addresses is recorded in the discovery database. In this embodiment, the database of information pertaining to devices of interest is a “stolen hardware database” which is maintained, for example, by an independent service provider or a law enforcement agency. When hardware is reported stolen, unique identifying information about the device is entered into the stolen hardware database. A “report generator system” periodically searches the discovery database for hardware that matches identifying information recorded in the stolen hardware database. When it finds a match, it outputs a report containing the network address(es) of the discovered device(s). Network addresses from these reports can be traced through the Internet service providers that registered them to locate and recover the hardware.

In accordance with another embodiment of the present invention, a method for locating and recovering devices which are connected to the Internet or to an Internet-connected computer network includes the steps of: employing one or more discovery techniques to discover devices on the Internet or on an Internet-connected computer network; acquiring identifiers of discovered devices; storing information pertaining to the discovered devices in a discovery database; accessing a database of information pertaining to devices of interest; comparing the identifiers to the database of information to identify devices of interest among the discovered devices; tracing network addresses of the identified devices of interest; and providing information pertaining to the identified devices of interest and/or the discovered devices to a party of interest. In a preferred embodiment, the one or more discovery techniques comprises an Internet Protocol (IP) range walk discovery technique which includes the steps of: sending request packets to a range of IP addresses; and receiving responses from discovered devices. The request packets include, by way of example, Simple Network Management Protocol (SNMP) request packets. In a preferred embodiment, the range of IP addresses includes all possible addresses within that range. In a preferred embodiment, the one or more discovery techniques comprises an Address Resolution Protocol (ARP) table walk discovery technique which includes the steps of: (a) communicating with a group of known devices to obtain IP and hardware addresses of other devices which have communicated with the group of know devices to discover additional groups of devices; and (b) repeating step (a) for the additional groups of devices. The IP and hardware addresses are obtained, for example, from an ARP table. In a preferred embodiment, step (b) is repeated recursively. The devices of interest include, by way of example, stolen or missing devices. In a preferred embodiment, the network addresses of the identified devices of interest are traced through an Internet Service Provider (ISP). The party of interest is, for example, a law enforcement agency or a purchaser of market research data.

In accordance with another embodiment of the present invention, a method for locating and recovering devices which are connected to the Internet or to an Internet-connected computer network includes the steps of: collecting device information pertaining to a group or groups of devices; moving selected portions of the device information as needed to a database of information pertaining to devices of interest; employing a discovery server to discover devices on the Internet or on an Internet-connected computer network; acquiring identifiers of discovered devices; storing information pertaining to the discovered devices in a discovery database; accessing the database of information pertaining to devices of interest; and comparing the identifiers to the database of information to identify devices of interest among the discovered devices. The devices of interest include, by way of example, stolen or missing devices. In a preferred embodiment, the method also includes the step of tracing network addresses of the identified devices of interest. In a preferred embodiment, the method also includes the step of providing information pertaining to the identified devices of interest and/or the discovered devices to a party of interest.

In accordance with another embodiment of the present invention, a method for locating and recovering devices which are connected to the Internet or to an Internet-connected computer network includes the steps of: employing one or more discovery techniques to discover devices on the Internet or on an Internet-connected computer network, the one or more discovery techniques comprising a range walk discovery technique which includes the steps of distributing network queries over a plurality of sub-networks at the same time, and receiving responses from discovered devices; acquiring network addresses and identifiers of discovered devices; storing information pertaining to the discovered devices in a discovery database; accessing a database of information pertaining to devices of interest; and comparing the identifiers to the database of information to identify devices of interest among the discovered devices. In a preferred embodiment, addresses of the network queries are ordered to avoid overloading any individual remote network. In a preferred embodiment, the network queries are made in batches. In a preferred embodiment, the queries in each batch include queries made to a plurality of different networks. In a preferred embodiment, the method also includes the step of tracing the network addresses of the identified devices of interest. In a preferred embodiment, the method also includes the step of providing information pertaining to the identified devices of interest and/or the discovered devices to a party of interest.

The above described and many other features and attendant advantages of the present invention will become apparent as the invention becomes better understood by reference to the following detailed description when considered in conjunction with the accompanying drawings.

### BRIEF DESCRIPTION OF THE DRAWINGS

Detailed description of preferred embodiments of the invention will be made with reference to the accompanying drawings:

FIG. 1 is a diagram illustrating Internet-based recovery of devices according to an exemplary preferred embodiment of the present invention;

FIG. 2 is a flow diagram illustrating an exemplary preferred method for locating and recovering devices which are connected to the Internet or to an Internet-connected computer network according to the present invention; and

FIG. 3 is a flow diagram illustrating an exemplary preferred method according to the present invention for creating and updating the stolen hardware database of FIG. 1.

### DETAILED DESCRIPTION OF THE PREFERRED EMBODIMENTS

The following is a detailed description of the best presently known mode of carrying out the invention. This description is not to be taken in a limiting sense, but is made merely for the purpose of illustrating the general principles of the invention.

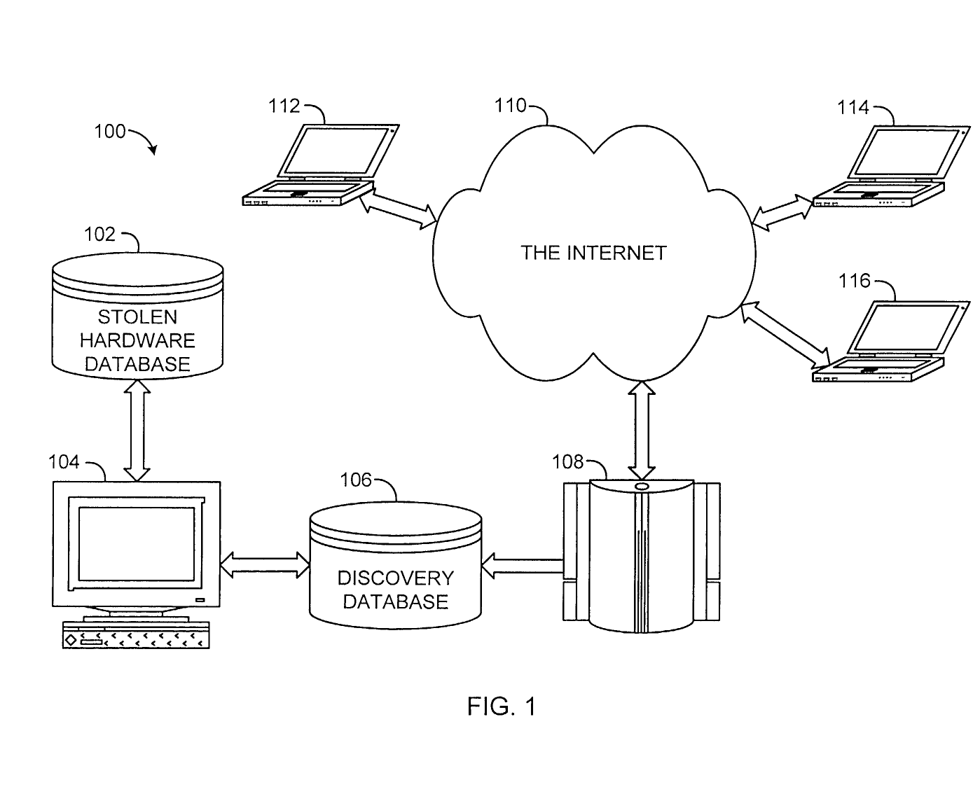

FIG. 1 illustrates a system 100 according to the present invention for locating devices which are connected to the Internet 110 or to any Internet-connected computer network. In the illustrated embodiment, the system 100 includes a stolen hardware database 102, a report generator system 104, a discovery database 106 and a discovery server 108 configured as shown. Devices 112, 114, 116 (shown as notebook computers) are connected to the Internet 110. It should be appreciated that the principles of the present invention are applicable to any device capable of network connectivity (for example, printers, hubs, routers and other infrastructure pieces), whether with the Internet 110, an Internet-connected computer network, or any other network.

The system 100 provides a mechanism for discovering and identifying stolen or lost devices (or hardware) which have been reconnected to the Internet 110. According to the present invention, the discovery server 108 is controlled to search the Internet 110 for devices and to collect information about discovered devices. Preferably, the collected information comprises unique identifying information (e.g., hardware addresses and serial numbers) for each of the discovered network-attached devices. The information is obtained via queries (e.g., management protocol queries) made by the discovery server 108.

The discovery server 108 employs one or more discovery techniques to discover devices on the Internet 110 or on an Internet-connected network. An exemplary preferred discovery technique employs a “range walk” through one or more groups of addresses. Another exemplary preferred discovery technique employs a “table walk” whereby identifying information (for devices which have recently communicated with a discovered device) are used recursively to discover additional devices and obtain their identifying information. In a preferred embodiment, the discovery server 108 runs continuously, querying the Internet 110 looking for connected devices.

The system 100 also provides a mechanism for locating and recovering stolen or lost devices. When a device is found, the network address of the device and any unique identifier information, such as serial numbers and hardware addresses, are recorded in the discovery database 106. Another database, the stolen hardware database 102, contains information concerning stolen devices. The databases are cross referenced and stolen hardware is identified. If the hardware is stolen, its network address is traced (for example, through the ISP) and the stolen hardware can be located and recovered. Alternatively, the report generator system 104 can periodically search the discovery database 106 for hardware that matches identifying information recorded in the stolen hardware database 102. When the report generator system 104 finds a match, it outputs a report containing the network address(es) of the discovered device which can also be traced. More generally, the stolen hardware database 102 can be a database of information pertaining to devices of interest.

In a preferred embodiment, the discovery server 108 is configured to automatically discover network-connected devices employing one or more discovery techniques. For example, devices can be discovered by sending Packet Internet or Inter-Network Groper (Ping) messages (packets) to IP addresses and listening for replies—to verify that particular IP addresses exist and can accept requests. Devices can also be discovered using Service Locator Protocol (SLP) where, after a generic broadcast packet, devices respond with a packet containing basic device information. Service Locator Protocol can automatically detect devices by listening for Multicast SLP Packets on a network. On some Novell-type networks, device information is broadcast periodically in the form of Service Advertisement Protocol (SAP) updates. This information can be used to determine what device is on the network. Also, by way of example, network packet capture can be employed to listen to packets that a device puts onto a network and use the contents of the packets to determine basic device information. Other discovery techniques can also be employed.

Once it is determined that a device exists at a particular address, the device is queried using protocols such as Simple Network Management Protocol (SNMP) and Desktop Management Protocol (DMI) to look for identifiers that can be used to uniquely identify the device. Exemplary identifiers for a network-connected device include its Media Access Control (MAC) address and serial number which is unique for every make and model. Other management protocols and industry frameworks can also be employed to obtain device identifiers.

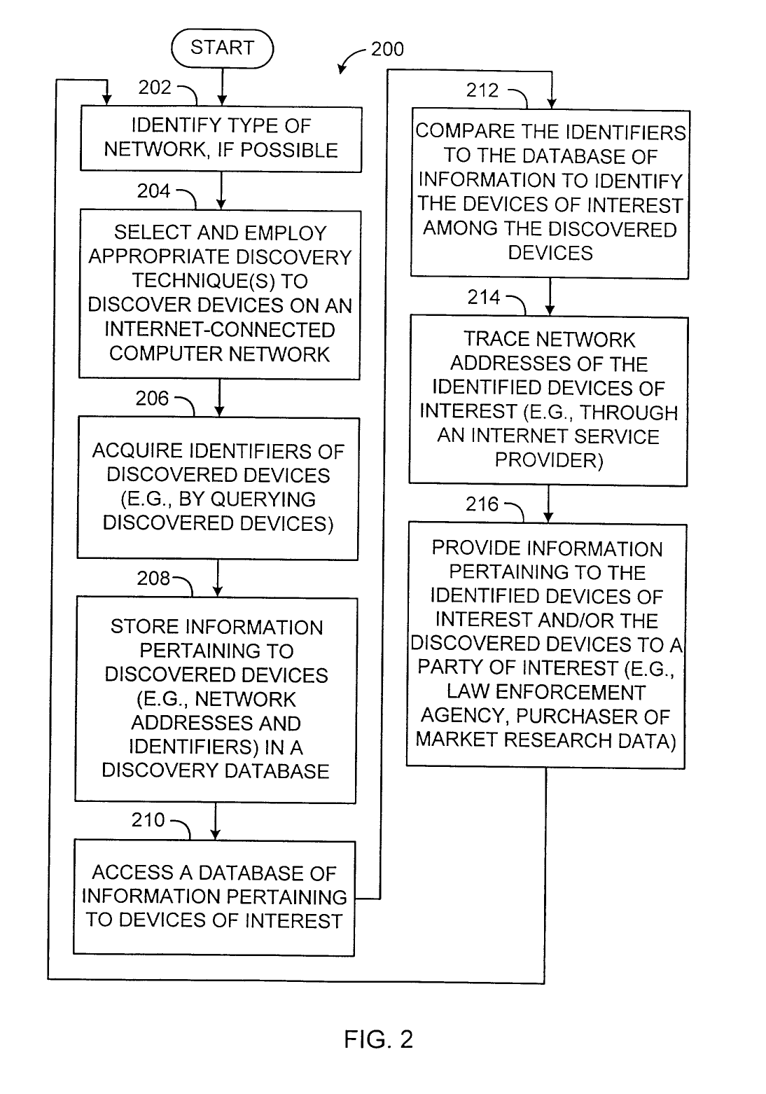

Referring to FIG. 2, an exemplary method 200 for locating and recovering devices which are connected to the Internet 110 or to an Internet-connected computer network is illustrated. Depending upon the type of network to be searched, different discovery techniques may be more effective and/or efficient at discovering devices than others. Accordingly, at step 202, the type of network is identified, if possible. At step 204, one or more discovery techniques are selected and employed to discover devices on the network of interest, e.g., the Internet 110 or an Internet-connected computer network.

An exemplary preferred discovery technique employs a “range walk” (e.g., an IP Range Walk employing SNMP requests) through one or more groups of addresses. Communication is attempted with all possible addresses, typically in sequence. In a preferred embodiment, this discovery technique is employed to walk the entire Internet 110 looking for network-attached devices. Alternatively, this discovery technique can be used to search part of the Internet 110 rather than all of it, or networks other than the Internet 110.

In a preferred “range walk” discovery technique, network queries are spread over a large number of sub-networks simultaneously. Preferably, the network queries are ordered to avoid overloading any individual remote network. While the total volume of discovery traffic may be very high at the discovery server 108, the even distribution of packets across the Internet 110 keeps the load on any one network very low, thus providing a “low bandwidth consumption” discovery technique according to the present invention. In an exemplary preferred embodiment, the network queries are made in batches and each batch includes queries made to a plurality of different networks (destination networks, physical networks).

The first number of a network address is the most significant and the last number is the least significant. The first two or three numbers indicate the destination network, and the last one or two indicate the host on that network. The more initial numbers two addresses have in common, the more likely they are to be on the same physical network.

According to an exemplary method of the present invention, a packet is sent to every possible address and the packets are sent out in batches. In order to minimize network impact to the remote networks, the packets are spread out so that all of the packets in a batch do not go to the same network and overload it.

If the batch size is five, a possible batch is:

10.1.1.1

10.1.1.2

10.1.1.3

10.1.1.4

10.1.1.5

Unfortunately, because of the hierarchical nature of the address assignments, these hosts are probably all on the same network (10.1.1). For very large batch sizes where large numbers of packets are addressed to a common destination network, a low-bandwidth network link can be overwhelmed. According to the present invention, a better (preferred) batch is shown below:

10.1.1.1

11.1.1.1

12.1.1.1

13.1.1.1

14.1.1.1

These addresses are all on different networks, so each network only sees one packet from the batch. Although the discovery server 108 may need a high-bandwidth network connection, each remote network sees only a small number of packets at a time.

The next batch might be:

10.1.1.2

11.1.1.2

12.1.1.2

13.1.1.2

14.1.1.2

By choosing the batches in this way, network queries are spread over a large number of sub-networks simultaneously, minimizing the negative impact of discovery traffic.

Another exemplary preferred discovery technique employs a “table walk” (e.g., an ARP Table Walk) whereby identifying information (for devices which have recently communicated with a discovered device) are used recursively to discover additional devices and obtain their identifying information. Each IP-capable node (device) on the Internet 110 maintains a cache (called the ARP cache) which lists all of the nodes that the original node communicates with. The ARP cache also includes the MAC address and IP address for each of the nodes. Devices differ in the length of time they retain this cache, but it is usually measured in minutes.

According to the present invention, an exemplary preferred table walk discovery technique involves recursively talking to a node and asking that node about all of the other nodes that it is aware of. By asking a host for its cache (e.g., via SNMP) and then asking each referenced host for its cache, and so on, a great number of devices can be discovered. This mechanism is very efficient, because broadcast traffic to nonexistent devices is avoided. However, it is less complete than a range walk because it only discovers a group of hosts that are talking to each other on a regular basis. To discover a greater number of hosts, a greater number of starting points are employed to ensure that a large portion of the Internet 110 or other network of interest is covered. Any of the discovery techniques discussed above can be used in conjunction with other discovery techniques. For example, Microsoft Corporation's AutoDiscovery technology uses SNMP or Ping, or searches ARP caches, as a method for discovering devices on an enterprise network, specific networks or IP addresses, or a range of IP addresses.

When a device is found, any unique identifier information, such as serial numbers and hardware addresses, are obtained at step 206 via management protocols (SNMP, DMI, etc.) and recorded (along with the network address of the device previously obtained by discovering the device) at step 208 in the discovery database 106. At step 210, a database of information pertaining to devices of interest (e.g., the stolen hardware database 102) is accessed. At step 212, the discovered device identifiers are compared to the database of information pertaining to devices of interest to identify devices of interest among the discovered devices. Once a device of interest is located, at step 214, its network address can be traced (e.g., through the ISP that provides it). In addition or as an alternative to step 214, information pertaining to the identified devices of interest and/or the discovered devices can be provided to a party of interest, such as a law enforcement agency. Another potential party of interest is a purchaser of market research data who, for example, may wish to gather information about how, where, etc. network-connected devices are being used. It is further contemplated that the method of the present invention can be implemented with appropriate safeguards to address privacy issues and concerns.

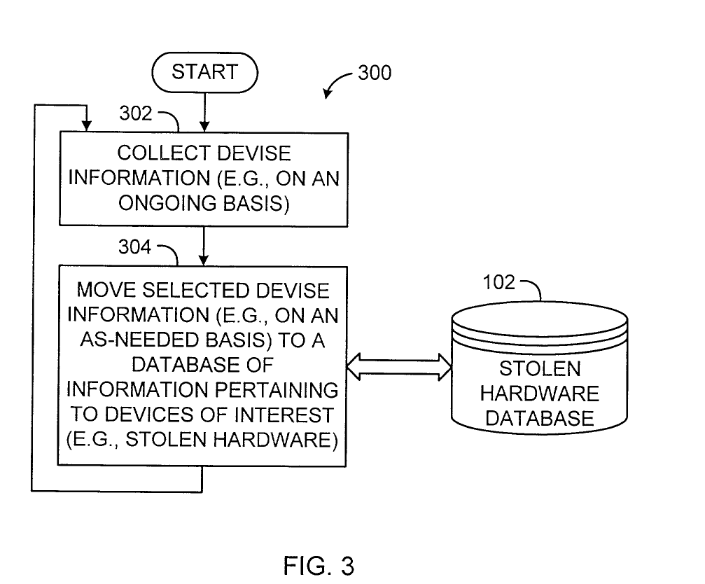

Referring to FIG. 3, a method 300 for creating and maintaining the database of information pertaining to devices of interest (e.g., the stolen hardware database 102) is illustrated. At step 302, devise information is collected (e.g., on an ongoing or periodic basis). At step 304, selected devise information is moved (e.g., on an as-needed basis) to the database of information pertaining to devices of interest.

By way of example, device information about a particular make and model of notebook computer are collected (step 302) as these devices are sold. When one of the notebook computers is stolen or misplaced, this is reported and information pertaining to that particular device is moved (step 304) to the stolen hardware database 102. The database of information pertaining to devices of interest is maintained, for example, by the hardware vendor, an independent service provider or a law enforcement agency.

Although the present invention has been described in terms of the preferred embodiment above, numerous modifications and/or additions to the above-described preferred embodiment would be readily apparent to one skilled in the art. It is intended that the scope of the present invention extends to all such modifications and/or additions.

We claim:

1. A method for locating and recovering devices which are connected to the Internet or to an Internet-connected computer network, the method comprising the steps of:
employing one or more discovery techniques to discover devices on the Internet or on an Internet-connected computer network;
acquiring identifiers of discovered devices;
storing information pertaining to the discovered devices in a discovery database;
accessing a database of information pertaining to devices of interest;
comparing the identifiers to the database of information to identify devices of interest among the discovered devices;
tracing network addresses of the identified devices of interest; and
providing information pertaining to the identified devices of interest and/or the discovered devices to a party of interest.

2. The method for locating and recovering devices of claim 1, wherein the one or more discovery techniques comprises an Internet Protocol (IP) range walk discovery technique which includes the steps of:
sending request packets to a range of IP addresses; and
receiving responses from discovered devices.

3. The method for locating and recovering devices of claim 2, wherein the request packets include Simple Network Management Protocol (SNMP) request packets.

4. The method for locating and recovering devices of claim 2, wherein the range of IP addresses includes all possible addresses within that range.

5. The method for locating and recovering devices of claim 1, wherein the one or more discovery techniques comprises an Address Resolution Protocol (ARP) table walk discovery technique which includes the steps of:
(a) communicating with a group of known devices to obtain IP and hardware addresses of other devices which have communicated with the group of know devices to discover additional groups of devices; and
(b) repeating step (a) for the additional groups of devices.

6. The method for locating and recovering devices of claim 5, wherein the IP and hardware addresses are obtained from an ARP table.

7. The method for locating and recovering devices of claim 5, wherein step (b) is repeated recursively.

8. The method for locating and recovering devices of claim 1, wherein the devices of interest comprise stolen or missing devices.

9. The method for locating and recovering devices of claim 1, wherein the network addresses of the identified devices of interest are traced through an Internet Service Provider (ISP).

10. The method for locating and recovering devices of claim 1, wherein the party of interest is a law enforcement agency.

11. The method for locating and recovering devices of claim 1, wherein the party of interest is a purchaser of market research data.

12. A method for locating and recovering devices which are connected to the Internet or to an Internet-connected computer network, the method comprising the steps of:
collecting device information pertaining to a group or groups of devices;
moving selected portions of the device information as needed to a database of information pertaining to devices of interest;
employing a discovery server to discover devices on the Internet or on an Internet-connected computer network;
acquiring identifiers of discovered devices;
storing information pertaining to the discovered devices in a discovery database;
accessing the database of information pertaining to devices of interest; and
comparing the identifiers to the database of information to identify devices of interest among the discovered devices.

13. The method for locating and recovering devices of claim 12, wherein the devices of interest comprise stolen or missing devices.

14. The method for locating and recovering devices of claim 12, further comprising the step of:
tracing network addresses of the identified devices of interest.

15. The method for locating and recovering devices of claim 12, further comprising the step of:
providing information pertaining to the identified devices of interest and/or the discovered devices to a party of interest.

16. A method for locating and recovering devices which are connected to the Internet or to an Internet-connected computer network, the method comprising the steps of:
employing one or more discovery techniques to discover devices on the Internet or on an Internet-connected computer network, the one or more discovery techniques comprising a range walk discovery technique which includes the steps of
distributing network queries over a plurality of sub-networks at the same time, and
receiving responses from discovered devices;
acquiring network addresses and identifiers of discovered devices;
storing information pertaining to the discovered devices in a discovery database;
accessing a database of information pertaining to devices of interest; and
comparing the identifiers to the database of information to identify devices of interest among the discovered devices.

17. The method for locating and recovering devices of claim 16, wherein addresses of the network queries are ordered to avoid overloading any individual remote network.

18. The method for locating and recovering devices of claim 16, wherein the network queries are made in batches.

19. The method for locating and recovering devices of claim 18, wherein the queries in each batch include queries made to a plurality of different networks.

20. The method for locating and recovering devices of claim 16, further comprising the step of:
tracing the network addresses of the identified devices of interest.

21. The method for locating and recovering devices of claim 16, further comprising the step of:
providing information pertaining to the identified devices of interest and/or the discovered devices to a party of interest.
